(19) United States
(12) Patent Application Publication
(10) Pub. No.: US 2011/0077155 A1
(43) Pub. Date: Mar. 31, 2011

(54) FERTILIZER COMPOSITIONS AND METHODS

(76) Inventor: Brian B. Goodwin, Collierville, TN (US)

(21) Appl. No.: 12/892,486

(22) Filed: Sep. 28, 2010

Related U.S. Application Data
(60) Provisional application No. 61/246,473, filed on Sep. 28, 2009.

(51) Int. Cl. C05F 11/02; A01N 25/00

(52) U.S. Cl. 504/101; 71/24; 504/358

(57) ABSTRACT

A composition of matter comprising a granular form contacted with a first component comprising an agriculturally acceptable complex mixture of organic material characterized by natural organic matter that is partially humified, where the first component is dispersed on at least a portion of the granular form, or mixed or admixed with the granular form. A method of improving plant health comprises the step of contacting a locus of a sown seed or plant with a granular form, a first component comprising an agriculturally acceptable mixture of partially humified natural organic matter, where, in the contacting step, the first component is initially or subsequently dispersed on at least a portion of granular form, or mixed or admixed with the granular form.

### CROSS REFERENCE TO RELATED APPLICATION

This application claims the benefit of U.S. Provisional Patent Application No. 61/246,473 filed on Sep. 28, 2009, the contents of which are hereby incorporated by reference herein in its entirety.

### TECHNICAL FIELD

The present disclosure relates to a granular form contacted with a first component comprising an agriculturally acceptable complex mixture of organic material and controlled release formulations thereof, and methods for improving overall plant health and reducing susceptibility of a plant to disease or pests using same.

### BACKGROUND

Various mixtures of organic compounds have been proposed in the art as fertilizer additives. Specifically, a humic acid composition, Bio-Liquid Complex™, is stated by Bio Ag Technologies International (1999) www.phelpstek.com/portfolio/humic_acid.pdf to assist in transferring micronutrients, more specifically cationic nutrients, from soil to plant.

TriFlex™ Bloom Formula nutrient composition of American Agritech is described as containing “phosphoric acid, potassium phosphate, magnesium sulfate, potassium sulfate, potassium silicate[and] sodium silicate.” TriFlex™ Grow Formula 2-4-1 nutrient composition of American Agritech is described as containing “potassium nitrate, magnesium nitrate, ammonium nitrate, potassium phosphate, potassium sulfate, magnesium sulfate, potassium silicate[and] sodium silicate.” Both compositions are said to be “fortified with selected vitamins, botanical tissue culture ingredients, essential amino acids, seaweed, humic acid, fulvic acid and carbohydrates.” See www.horticulturesource.com/product info.php/products_id/82. These products are said to be formulated primarily for “soilless hydrogardening” (i.e., hydroponic cultivation) of fruit and flower crops, but are also said to outperform conventional chemical fertilizers in container soil gardens. Their suitability or otherwise for foliar application as opposed to application to the hydroponic or soil growing medium is not mentioned. See www.americanagritech.com/product/product_detalasp?ID=I&pro_id_pk=4-0.

The trademark Monarch™, owned by Actagro, LLC is a fertilizer composition containing 2-20-15 primary plant nutrients with 3% non plant food organic compositions derived from natural organic materials.

### SUMMARY

There is now provided a composition of matter comprising a granular form contacted with a first component dispersed on at least a portion of the granular form, or mixed or admixed with the granular form. Optionally, a second component selected from agriculturally acceptable sources of pesticides, micronutrients, macronutrients, growth regulators, or mixtures thereof, is also dispersed on at least a portion of the granular form, or mixed or admixed with the granular form.

There is still further provided a method of improving plant health, the method comprising the step of contacting a locus of a sown seed or plant with a granular form and a first component comprising an agriculturally acceptable mixture of partially humified natural organic matter, where, in the contacting step, the first component is initially or subsequently dispersed on at least a portion of granular form, or mixed or admixed with the granular form.

There is still further provided a method comprising contacting a locus of a sown seed or plant with a granular form and a first component comprising an agriculturally acceptable mixture of partially humified natural organic matter, wherein, in the contacting step, the first component, is initially or subsequently dispersed on at least a portion of granular form, or mixed or admixed with the granular form; and enhancing one or more of germination, emergence, root development, and nutrient uptake of the sown seed or plant is provided compared to the locus of a sown seed or plant not contacted with the granular form and the first component.

There is still further provided a method for improving growth or nutrition of a plant, comprising applying a composition comprising the first component and a pesticide, optionally a plant nutrient, to a seed, a foliar surface of the plant, or the locus of the plant.

There is still further provided a method for delayed release nutrition for a plant or seed. The method comprises contacting the locus or the foliar surface of a plant or a seed with a granular form and a first component comprising an agriculturally acceptable mixture of partially humified natural organic matter, wherein, in the contacting step, the first component is initially or subsequently dispersed on at least a portion of granular form, or mixed or admixed with the granular form; wherein the release of an effective amount of the first component from the granular form is delayed for a predetermined time after the contacting step.

### BRIEF DESCRIPTION OF THE DRAWINGS

FIG. 1. Depicts experimental data of plant weight at 20, 34, and 54 days after emergence (DAE) of plants contacted with the first component and a granular fertilizer composition disclosed and described herein verses controls.

FIG. 2. Depicts experimental data of plant weight at 20, 34, and 54 days after emergence (DAE) of plants contacted with the first component and a granular fertilizer composition disclosed and described herein over a predetermined time after initial treatment verses controls.

### DETAILED DESCRIPTION

Disclosed and described herein is, in part, plant growth, nutrient, or health composition of matter, compositions, and methods comprising a granular form and a first component comprising a natural organic material of defined composition. Optionally, a second component comprising at least one pesticide (individually or collectively, a herbicide, an insecticide, a fungicide, a bactericide, an anti-viral, plant nutrient, or combinations thereof) is included. Compositions and methods disclosed and described herein vary depending on the intended method of application, the plant species to which they are to be applied, growing conditions of the plants, and other factors.

Compositions disclosed and described herein typically take the form of granules or particulates, generally the form is agriculturally acceptable to the locus of a sown seed or plant. The granular form can be of the type that degrades or releases over time and/or under agricultural conditions to provide at least the first component to the locus. The granular form itself can be a source of nutrition for the seed or plant.

The term “agriculturally acceptable” applied to a material or composition herein means not unacceptably damaging or toxic to a plant or its environment, and not unsafe to the user or others that may be exposed to the material when used as described herein.

The phrase “effective amount” refers to an amount of an active agent or ingredient (a.i.) that is agriculturally nontoxic but sufficient to provide the desired effect. For example, an effective amount of a first component comprising an agriculturally acceptable mixture of partially humified natural organic matter is an amount sufficient to measurably improve the germination, emergence, root development, and nutrient uptake of a sown seed or a plant. The effective amount varies according to the seed, locus, climate, season, mode of application, pre-existing nature of the locus, plant or seed, and any previous treatments which may be associated therewith, or any concurrent related or unrelated treatments or conditions of the locus, plant or seed. Effective amounts can be determined without undue experimentation by any person skilled in the art or by following the exemplary guidelines set forth in this application.

A “foliar surface” herein is typically a leaf surface, but other green parts of plants have surfaces that may permit absorption of the first or the second components, including petioles, stipules, stems, bracts, flowerbuds, etc., and for present purposes “foliar surfaces” will be understood to include surfaces of such green parts.

The term “granular” and the phrase “granular form” as used herein, refers to granules, particulates, beads, and combinations thereof. For example, granular forms are those suitable for dispensing equipment commonly used in an agricultural setting. Granular forms may be of any shape or size suitable for use in an agricultural setting or in agricultural equipment.

A “locus” as used herein is inclusive of a foliar surface and also includes an area in proximity to a plant or the area in which a plurality of seed is sown or about to be sown. For example, the locus of a crop would include the soil and may further include parts of the crop sown or growing in the soil.

The term “seed” as used herein, is not limited to any particular type of seed and can refer to seed from a single plant species, a mixture of seed from multiple plant species, a seed blend from various strains within a plant species, or a genetically modified seed (GM). The disclosed and described compositions and methods can be utilized to treat gymnosperm seed, dicotyledonous angiosperm seed and monocotyledonous angiosperm seed.

### The First Component

The first component of the composition disclosed and described herein comprises a mixture of organic molecules isolated and extracted from sources rich in natural organic matter into an aqueous solution. The natural organic matter is primarily derived from plant materials that have been modified to varying degrees over time in a soil environment. Some of the plant materials have been recently deposited in the environment. At least a part of the natural organic matter has passed through a partial process of humification to become partially humified natural organic matter. Humification includes microbial, fungal, and/or environmental (heat, pressure, sunlight, lightning, fire, etc.) degradation and/or oxidation of natural organic matter. Most preferably, the first component contains natural organic matter that has not substantially undergone humification (partially humified natural organic matter). In one aspect, the natural organic matter is obtained from environments typically containing or providing anywhere between about 5 ppm, to about 500 ppm of dissolved organic matter (DOM). In other aspects, the natural organic matter is obtained from environments typically containing or providing between about 500 ppm to about 3000 ppm or more DOM.

Natural organic matter is extremely complex, with thousands of compounds generally present, depending upon the source and the environmental conditions prevalent about the source. Humic substances such as Fulvic Acid (CAS No. 479-66-3) and Humic Acid (CAS No. 1415-93-6) are examples of organic complexes that are derived from natural organic matter, however, The first component is chemically and biologically unique from Fulvic and Humic acid, as detailed below.

The first component contains dissolved organic matter, the organic matter being formed during the process of humification as described above, such as microbial, fungicidal, and/or environmental (heat, pressure, sunlight, lightning, fire, etc.) degradation processes. Other natural or synthetic natural organic matter degradation processes may be involved or may be used. In one aspect, the first component contains predominately natural organic matter that has not undergone substantial humification (e.g., partially humified natural organic matter). The amount of humification may be determined and characterized using known methods, for example, by 13C NMR.

In one aspect, the first component is obtained by removing a natural organic matter from its source, optionally processing, and/or concentrating to provide the first component having a dissolved organic matter (DOM) concentration level of from anywhere between about 10× to about 5000× relative to its original source. In another aspect, the first component concentrations of dissolved organic matter (DOM) concentration level can be between about 7500× up to about 50,000×. The first component may be adjusted such that the concentration of DOM is between about 10 ppm to about 700,000 ppm. Preferably, the first component may be adjusted such that the concentration of DOM is between about 1000 ppm to about 500,000 ppm. The first component may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× of the original source can contain about 550,000 ppm of DOM. In certain aspects, the first component are approximately between about 91% to about 99% water, the remaining organic material being primarily DOM with minor amounts of alkali-, alkali earth-, and transition metal salts. In yet other aspects, the DOM of the first component has been dried or lyophilized in a form suitable for reconstitution with an aqueous solution.

The first component is a complex mixture of substances, typically a heterogeneous mixture of compounds for which no single structural formula will suffice. Elemental and spectroscopic characterization of the first component differentiates it from most other humic-based organic complexes, such as Humic and Fulvic Acids, as further discussed below. Blending of individual batches of the first component may be performed to provide consistency and to compensate for the normal variations of a naturally-derived material.

Detailed chemical and biological testing has shown that the complex mixture of substances of the first component is a unique composition both in its biological effect on plants and its chemical composition compared to Humic and Fulvic acids.

### Characterization and Methods for the First Component

The organic compounds making up the first component of the composition, can be characterized in a variety of ways (e.g., by molecular weight, distribution of carbon among different functional groups, relative elemental composition, amino acid content, carbohydrate content, etc.). In one aspect, the first component was characterized relative to known standards of humic-based substances.

For purposes of characterizing carbon distribution among different functional groups, suitable techniques include, without limitation, 13C-NMR, elemental analysis, Fourier transform ion cyclotron resonance mass spectroscopy (FTICR-MS) and Fourier transform infrared spectroscopy (FTIR). The chemical characterization of the first component and Humic substance standards were carried out using Electro spray Ionization Fourier Transform Ion Cyclotron Resonance Mass Spectroscopy (ESI-FTICR-MS), Fourier Transform Infrared Spectroscopy (FTIR) and elemental analysis for metals using ICP-AES, conducted by Huffman Laboratories, Inc. and the University of Washington.

Elemental, molecular weight, and spectroscopic characterization of the first component is consistent with an organic complex that consists primarily of lignin and tannin compounds (and mixtures of condensed and un-condensed tannin), condensed aromatics and trace amounts of lipid and inorganics. Thousands of compounds are present, with molecular weights ranging from 225 to 700 daltons, the majority of compounds having between about 10 to about 39 carbon atoms per molecule. The first component is generally composed of carbon, oxygen, and hydrogen, with small amounts of nitrogen, and sulfur. The first component also contains potassium and iron at levels above 5%.

The elemental composition of the dissolved solids typically present in the first component is given in Table A. If the organic compounds are separated from the inorganic elements, the elemental breakdown is: C 55%, H 4%, O 38%, N 1.8%, and S 2.2%.

TABLE A
Average Elemental Composition of dissolved solids in the first
component, based upon average values from 10 different lots.

| Element | % |
|---|---|
| Carbon | 35.1 |
| Oxygen | 24.6 |
| Hydrogen | 2.5 |
| Sulfur | 2.1 |
| Nitrogen | 1.3 |
| Potassium | 27.3 |
| Iron | 6.1 |
| Calcium | 0.2 |
| Sodium | 0.2 |
| Phosphorous | 0.1 |
| Other | 0.5 |

Among the classes of organic compounds present in the first component, analysis generally reveals that there are lignin and tannin (mixture of condensed and un-condensed), condensed aromatics, unidentified substances and some lipids present. Each of these classes of compounds is further characterized by a rather narrow Mw range and number of carbons/molecule. The breakdown of the number and percentage of each of the various compound classes, their MW's and carbon atoms/molecule (Carbon Range) for a representative sampling of the first component is given in B1.

TABLE B1
Compound Classes in CP along with size and carbon
ranges for compounds in each class. Based upon
composite of 3 different production batches.

| | # Com- | % of | Size Range | Carbon |
|---|---|---|---|---|
| Compound Class | pounds | Total | (daltons) | Range |
| Lignin | 1139 | 57 | 226-700 | 11 to 39 |
| Tannin | 587 | 30 | 226-700 | 10 to 31 |
| Condensed Aromatic | 220 | 11 | 238-698 | 13 to 37 |
| Lipid | 18 | 1 | 226-480 | 14 to 30 |
| Carbohydrate | 1 | 0 | 653 | 24 |
| Other | 23 | 1 | 241-651 | 12 to 33 |

Results for individual batches are very similar.

A breakdown of the number and percentage of each of the various compound classes, their MW's and carbon atoms/molecule (Carbon Range) for a second representative sampling based upon an average of 3 different production batches for the composition of matter is given in Table B2.

TABLE B2
Compound Classes in the composition of matter, along with
size and carbon ranges for compounds in each class. Based
upon average of 3 different CP production batches.

| | # Com- | % of | Size Range | Carbon |
|---|---|---|---|---|
| Compound Class | pounds | Total | (daltons) | Range |
| Lignin | 711 | 56 | 226-700 | 11 to 39 |
| Tannin | 410 | 33 | 226-700 | 10 to 31 |
| Condensed Aromatic | 122 | 10 | 238-698 | 13 to 37 |
| Lipid | 12 | ~1 | 226-480 | 14 to 30 |
| Carbohydrate | 1 | 0 | 653 | 24 |
| Other | 14 | ~1 | 241-651 | 12 to 33 |

Results for individual batches are very similar.

Table C, summarizes the oxygen-to-carbon (O/C) and hydrogen-to-carbon (H/C) ratios used in defining the classes described above. In one aspect, the CP composition is characterized in that the O/C ratio of the dissolved organic matter is greater than about 0.4 as measured by mass spectroscopy. In one aspect, the CP composition is characterized in that the H/C ratio of the dissolved organic matter is greater than about 0.8 as measured by mass spectroscopy. In another aspect, the CP composition is characterized in that the H/C ratio of the dissolved organic matter is greater than about 0.85 as measured by mass spectroscopy.

TABLE C
Elemental Ratios and chemical classifications
used in characterizing CP samples.

| Class | O/C | H/C | Aromaticity Index |
|---|---|---|---|
| Lignin | 0.15-0.6 | 0.6-1.7 | <0.7 |
| Tannin | 0.6-1.0 | 0.5-1.4 | <0.7 |
| Condensed Aromatic | 0.1-0.7 | 0.3-0.7 | >0.7 |
| Lipid | 0-0.2 | 1.8-2.2 | |
| Carbohydrate | 0.6-1.0 | 1.8-2.2 | |

Comparison with Humic Substance Standards

Comparative elemental and structural characterization of Humic Substances verses samples of the first component were performed. Three humic substances standards from the International Humic Substances Society were used: Leonardite Humic Acid (LHA), Pahokee Peat Humic Acid (PPHA), and Suwannee River Fulvic Acid II (SRFA). Each humic substance standards and each sample of the first component was analyzed by FTIR and ESI-FTICR-MS. A portion of each humic substance standard was dissolved in NH₄OH/water for the ESI-FTICR-MS analysis. Three samples of the first component (#1, #2, and #3) were prepared for analysis with cation exchange resin (AG MP-50, Bio-Rad Laboratories, Hercules, Calif.). Comparison of the Humic Substance standards and each sample of the first component is presented in Table D.

TABLE D
Comparison of humic substance standards
samples of the first component.

| Sample | O/C | H/C | DBE | Avg. MW |
|---|---|---|---|---|
| Suwannee River Fulvic Acid (SRFA) | 0.39 | 1.01 | 12.7 | 445.7 |
| Pahokee Peat Humic Acid (PPHA) | 0.34 | 0.75 | 16.29 | 429.8 |
| Leonardite Humic Acid (LHA) | 0.3 | 0.79 | 15.8 | 423.6 |
| #1 | 0.54 | 0.87 | 13.7 | 472.9 |
| #2 | 0.54 | 0.89 | 13.23 | 456.9 |
| #3 | 0.5 | 0.91 | 13.23 | 455.7 |

Table D indicates that there are major differences between the Humic Substances standards and the samples representing the first component. For example, the O/C ratio is less than 0.4 in all of the Humic Substances but is over 0.5 for the first component samples. The DBE for the samples is also significantly lower than for the Humic Acid Standards and the average MW is greater.

Based on mass spectral analysis, there are a number of compounds present in the first component samples that are substantially absent or greatly reduced in the Humic Substance standards. In particular, at least one component of the first component may correspond with one or more tannin compounds. By comparison, in the Humic Substance standards, the % of tannin compounds are present in a small amount. For example, in the Fulvic Acid standard and in the Humic Acid standards, both standards are at least 3×-4× less than the % tannins found in the first component samples, as shown in Table E.

TABLE E
Number and % tannins in Humic Substance
Standards verses first component samples.

| | | % of tannin |
|---|---|---|
| Sample | # tannins | compounds |
| Suwannee River Fulvic Acid (SRFA) | 192 | 8.8 |
| Pahokee Peat Humic Acid (PPHA) | 9 | 1.2 |
| Leonardite Humic Acid (LHA) | 22 | 1.2 |
| #1 | 441 | 35.2 |
| #2 | 357 | 34.6 |
| #3 | 432 | 28.3 |

Comparing the Fourier Transform Infrared (FTIR) spectra for the IHSS standards and first component samples, there are similarities, primarily in the region from 1600 to 1800 cm⁻¹. In both sets of samples we see a very strong peak at around 1700 cm⁻¹ due to the C═O stretch from a carboxyl functional group and a peak in the 1590 to 1630 region which is consistent with a C═C bond from alkenes or aromatics. However, significant differences in the region from 700 to 1450 cm⁻¹ are observed. Peaks at 1160 to 1210 are present in all the spectra and are from the C—O bond of alcohols, ethers, esters and acids. The biggest difference is the peak at 870 cm⁻¹ in the first component samples, which is absent in the IHSS standards. This peak may be due to the C—H bond of alkenes and aromatics.

Based on the characterization data, the first component may contain relatively small molecules or supramolecular aggregates with a molecular weight distribution of about 300 to about 18,000 daltons. Included in the organic matter from which the mixture of organic molecules are fractionated are various humic substances, organic acids and microbial exudates. The mixture is shown to have both aliphatic and aromatic characteristics. Illustratively, the carbon distribution shows about 35% in carbonyl and carboxyl groups; about 30% in aromatic groups; about 18% in aliphatic groups, about 7% in acetal groups; and about 12% in other heteroaliphatic groups.

In some embodiments, the mixture of compounds in the first component comprises organic molecules or supramolecular aggregates with a molecular weight distribution of about 300 to about 30,000 daltons, for example, about 300 to about 25,000 daltons, about 300 to about 20,000 daltons, or about 300 to about 18,000 daltons.

Characterizing carbon distribution among different functional groups, suitable techniques can be used include without limitation 13C-NMR, elemental analysis, Fourier transform ion cyclotron resonance mass spectroscopy (FTICR-MS) and Fourier transform infrared spectroscopy (FTIR).

In one aspect, carboxy and carbonyl groups together account for about 25% to about 40%, for example about 30% to about 37%, illustratively about 35%, of carbon atoms in the mixture of organic compounds of the first component.

In one embodiment, aromatic groups account for about 20% to about 45%, for example about 25% to about 40% or about 27% to about 35%, illustratively about 30%, of carbon atoms in the mixture of organic compounds of the first component.

In one embodiment, aliphatic groups account for about 10% to about 30%, for example about 13% to about 26% or about 15% to about 22%, illustratively about 18%, of carbon atoms in the mixture of organic compounds of the first component.

In one embodiment, acetal and other heteroaliphatic groups account for about 10% to about 30%, for example about 13% to about 26% or about 15% to about 22%, illustratively about 19%, of carbon atoms in the mixture of organic compounds of the first component.

In one aspect, the ratio of aromatic to aliphatic carbon is about 2:3 to about 4:1, for example about 1:1 to about 3:1 or about 3:2 to about 2:1 in the first component.

In a particular illustrative aspect, carbon distribution in the mixture of organic compounds of the first component is as follows: carboxy and carbonyl groups, about 35%; aromatic groups, about 30%; aliphatic groups, about 18%, acetal groups, about 7%; and other heteroaliphatic groups, about 12%.

Elemental composition of the organic compounds of the first component is independently in one series of embodiments as follows, by weight: C, about 28% to about 55%, illustratively about 38%; H, about 3% to about 5%, illustratively about 4%; 0, about 30% to about 50%, illustratively about 40%; N, about 0.2% to about 3%, illustratively about 1.5%; S, about 0.2% to about 4%, illustratively about 2%.

Elemental composition of the organic compounds of the first component is independently in another series of embodiments as follows, by weight: C, about 45% to about 55%, illustratively about 50%; H, about 3% to about 5%, illustratively about 4%; 0, about 40% to about 50%, illustratively about 45%; N, about 0.2% to about 1%, illustratively about 0.5%; S, about 0.2% to about 0.7%, illustratively about 0.4%.

In a particular illustrative aspect, elemental distribution is, by weight: C, about 38%; H, about 4%; 0, about 40%; N, about 1.5%; and S, about 2%. The balance consists mainly of inorganic ions, principally potassium and iron in the first component.

In another particular illustrative aspect, elemental distribution is, by weight: C, about 50%; H, about 4%; 0, about 45%; N, about 0.5%; and S, about 0.4% in the first component.

Among classes of organic compounds that can be present in the first component are, in various aspects, amino acids, carbohydrates (monosaccharides, disaccharides and polysaccharides), sugar alcohols, carbonyl compounds, polyamines, lipids, and mixtures thereof. These specific compounds typically are present in minor amounts, for example, less than 5% of the total % of compounds.

Examples of amino acids that can be present include without limitation arginine, aspartic acid, glutamic acid, glycine, histidine, isoleucine, serine, threonine, tyrosine and valine.

Examples of monosaccharide and disaccharide sugars that can be present include without limitation glucose, galactose, mannose, fructose, arabinose, ribose and xylose.

Based on the above chemical, elemental and structural characterization, the first component is chemically and biologically unique from Humic and Fulvic acids or combinations thereof. Further, as a result of the nature and extent of gene regulation and over all effect of the first component with respect to improved plant health, drought and salinity stress resistance, it is generally believed that the first component is unique to that of known humic and/or fulvic acid compositions and treatments, for which such activity and properties are generally lacking in quality and quantity. Other beneficial plant function attributes of the first component may be present or result from the methods of treatment and/or the gene regulation obtained from the first component.

Without being bound by theory, it is believed that at least the ability of the first component to complex ions assists in plant nutrition by facilitating uptake and/or translocation of ions in the plant. Facilitating uptake and/or translocation of ions may occur through preferential movement of ions via the xylem or phloem to the growing and fruiting points of the plant. Alternatively, or in combination with the above, facilitating uptake and/or translocation of ions may occur through regulation of one or more genes related to ion transport or other biological function of the plant or seed. Facilitating uptake and/or translocation of ions may occur through absorption and transport via the seed coat of the pre- or post-planted seed. Inorganic ions can be positively charged cations or negatively charged anions. Examples of inorganic cations include Mg²⁺, Ca²⁺, Fe²⁺ and Fe³⁺. Examples of inorganic anions include borate and silicate. Such reversible binding or complexing may take the form of chelation or by ionic or non-ionic interaction. Other abilities of the first component to assists in plant nutrition can be present or employed.

A suitable mixture of organic compounds can be found in products marketed as Carbon Boost-S soil solution and KAFE™-F foliar solution of Floratine Biosciences, Inc. (FBS). Information on these products is available at www.fbsciences.com. Thus, exemplary compositions of aspects disclosed and described herein can be prepared by adding to Carbon Boost™-S or KAFE™-F foliar solution as the first component, at least one pesticide as the second component, to a suitable volume of water.

The amount of the first component that should be present in the composition depends on the particular organic mixture used. The amount should not be so great as to result in a physically unstable composition, for example by exceeding the limit of solubility of the mixture in the composition, or by causing other essential components to fall out of solution. On the other hand, the amount should not be so little as to fail to provide enhanced nutrition, growth, enhanced stress resistance, or enhanced pesticide/disease protection when applied to a target plant species. For any particular organic mixture, one of skill in the art can, by routine formulation stability and bioefficacy testing, optimize the amount of organic mixture in the composition for any particular use.

Particularly where a mixture of organic compounds, as found, for example, in the commercially available formulations sold under the tradenames Carbon Boost™-S and KAFE™-F, is used, the amount of the first component needed in a nutrition composition will often be found to be remarkably small. For example, as little as one part by weight (excluding water) of such a mixture can, in some circumstances, assist in foliar delivery of up to about 1000 or more parts by weight of the second component to a site of deposition in a plant. In other circumstances, it may be found beneficial to add a greater amount of the organic mixture, based on routine testing.

### The Second Component

The second component as used herein refers to at least one pesticide, where the term “pesticide” herein refers to at least one herbicide, insecticide, fungicide, bactericide, anti-viral, or a combination thereof. In one aspect, the second component is at least one insecticide and/or at least one fungicide. In yet another aspect, the second component is at least one bactericide and/or at least one antiviral.

Herbicides can include, for example, any herbicide that is effective for the control or remediation of weeds, for example imidazolinone, sulfonylurea, glyphosate, glufosinate, L-phosphinothricin, triazine, benzonitrile and combinations thereof. Herbicides also include Dicamba (3,6-dichloro-o-anisic acid or 3,6-dichloro-2-methoxybenzoic acid), the active ingredient in herbicides such as Banvel™, (BASF), Clarity™, (BASF), and Vanquish™ (Syngenta).

Insecticides can include, for example, any insecticide that is effective for the control or remediation of insects, and include ovicides and larvicides. Exemplary insecticides include organochlorines, organophosphates, carbamates, neonicotinoids, phenylpyrazoles, and pyrethroids, for example tefluthrin, terbufos, cypermethrin, thiodicarb, lindane, furathiocarb, acephate, butocarboxim, carbofuran, NTN, endosulfan, diethion, aldoxycarb, methiocarb, oftanol, (isofenphos), chlorpyrifos, bendiocarb, benfuracarb, oxamyl, parathion, capfos, dimethoate, fonofos, chlorfenvinphos, cartap, fenthion, fenitrothion, HCH, deltamethrin, malathion, disulfoton, and combinations thereof. In one aspect, the second component comprises an insecticidally effective amount of at least one neonicotinoid or phenylpyrazole insecticide, and combinations thereof.

Fungicides can include, for example any fungicide that is effective for the control of fungi and oomycetes, such as, those effective for the control or remediation of the phytopathogenic fungi belong to the Ascomycetes (Fusarium spp., Thielaviopsis spp., Verticillium spp., Magnaporthe grisea), Basidiomycetes (Rhizoctonia spp., Phakospora pachyrhizi Sydow, Puccinia spp.); and Oomycetes (Phytophthora, Pythium spp., Phytophthora spp.). Exemplary fungicides include Benomyl (also known as Benlate), Bitertanol, Captan, Carbendazim, Carboxin (also known as Carbathiin), Capropamid, Cymoxanil, Cyprodinil, Difenoconazole, Ethirimol, Fenpiclonil, Fenpropimorph, Fludioxonil, Fluquinconazole, Flutolanil, Flutriafol, Fosetyl-aluminum, Fuberidazole, Guazatine, Hymexanol, Kasugamycin, Imazalil, Imibenconazole, Iminoctadine-triacetate, Ipconazole, Iprodione, Mancozeb, Maneb, Mepronil, Metalaxyl, Metalaxyl-M (Mefenoxam), Metconazole, Metiram, MON 65500 (Silthiopham-ISO proposed), Myclobutanil, Nuarimol, Oxadixyl, Oxine-copper, Oxolinic acid, Perfurazoate, Pencycuron, Prochloraz, Propamocarb hydrochloride, Pyroquilon, Quintozene (also known as PCNB), Silthiopham—see MON 65500, Tebuconazole, Tecnazene, Tetraconazole, Thiabendazole, Thifluzamide, Thiophenate-methyl, Thiram, Tolclofos-methyl, Triadimenol, Triazoxide, Triflumizole, Triticonazole, and combinations thereof. In one aspect, the second component comprises a fungicidally effective amount of at least two fungicides including at least one phenylamide (acylalanine type), at least one phenylpyrrole, and at least one triazole. In another aspect, the second component comprises a fungicidally effective amount of at least three fungicides including at least one phenylamide (acylalanine type), at least one phenylpyrrole, and at least one triazole.

Bactericides can include, for example, any bactericides that are effective for the control or remediation of Agrobacterium, Burkholderia, Proteobacteria (e.g., Xanthomonas spp. and Pseudomonas spp.) Phytoplasma, and Spiroplasma.

Anti-viral agents can include, for example, agents that are effective for the control or remediation of asymptomatic viruses, nematodes protozoa and parasitic plants.

In one aspect, the second component comprises a combination of an insecticidally effective amount of at least one neonicotinoid or phenylpyrazole insecticide and a fungicidally effective amount of at least one fungicide selected from phenylamide (acylalanine type), phenylpyrrole or triazole. In one specific aspect, the second component comprises a combination of an insecticidally effective amount of at least one neonicotinoid or phenylpyrazole insecticide and a fungicidally effective amount of at least three fungicides including at least one phenylamide (acylalanine type), at least one phenylpyrrole, and at least one triazole.

The second component can also include one or more growth regulators, for example, cytokinins, auxins, gibberellins, and combinations thereof.

The second component can also comprise one or more plant macronutrients or plant micronutrients. The term “macronutrient” can refer to an element for plant growth which is utilized by plants in proportionally larger amounts relative to micronutrients. The term “micronutrients” refers to an element utilized by plants during growth which are used in smaller amounts relative to macronutrients. For example, plant macronutrients include nitrogen, potassium, phosphorus, calcium, magnesium and sulfur. The second component can comprise various combinations and relative amounts of individual macronutrients. For example, plant micronutrients include iron, manganese, zinc, copper, boron, molybdenum and cobalt. Numerous compounds and substances are available to provide micronutrients as the second component. Various combinations and relative amounts of micronutrients can be utilized in the second component.

Typically, a suitable ratio of the first component to the second component is about 1:2000 to about 1:5, for example about 1:1000 to about 1:10 or about 1:500 to about 1:20, illustratively about 1:100. If using Carbon Boost™-S or KAFE™-F solution as the source of organic compounds, a suitable amount of such solution to be included in a concentrate composition of second component herein is about 1 part by weight Carbon Boost™-S or KAFE™-F solution in about 5 to about 25, for example about 8 to about 18, illustratively about 12, parts by weight of the concentrate composition.

Optionally, additional components can be present in a composition of the present invention together with the first and second components as describe above. For example, the composition can further comprise as a third component at least one agriculturally acceptable source of a plant nutrient other than those used as the first and second component. Additional sources of these nutrients can be present, if desired.) Examples of other plant nutrients, sources of which can optionally be included, are potassium (K), and sulfur (S), phosphorus (P), calcium (Ca), magnesium (Mg), iron (Fe), zinc (Zn), manganese (Mn), copper (Cu) and boron (B).

Other ingredients can optionally be present in a composition disclosed and described herein, including such conventional formulation adjuvants as surfactants (for example to enhance wetting of leaf surfaces), spray drift controlling agents, antifoam agents, viscosity modulating agents, antifreezes, coloring agents, a mold inhibitor, an absorbant, a penetrant, etc. Any of these can be added if desired, so long as they do not destabilize essential components of the composition.

Granular Form Treated with First Component

In one aspect, a granular form is contacted with the first component to provide a composition of matter of manufacture. In one aspect, the composition of matter provides a controlled or delayed release form of the first component. Suitable granular forms can be clays and include, for example, montmorillonite, allapulgite, and hydrous aluminosilicate minerals. Montmorillonite mineral is from the non-swelling bentonite class of clays (e.g., from Ripley, Miss. and Mounds, Ill.). Montmorillonite has a low bulk density and high absorbtivity which allows higher liquid holding capacity of aqueous solutions of the first component. Attapulgite mineral, also known as Fuller's earth, is also from the non-swelling bentonite class and is obtained from Ochlocknee, Ga. Attapulgite's low bulk density and high absorbtivity allows higher liquid holding capacity of aqueous solutions of the first component. Hydrous aluminosilicate also has a low bulk density and high absorbtivity allowing for higher liquid holding capacity of aqueous solutions of the first component. Suitable clay granular forms for use with the first component as disclosed herein are available from Oil-Dri Corp. (Alpharetta, Ga.). The clay granule's micropore structure is adjusted to optimize the absorption and/or optimize release and/or optimize environmental stability of the first component for use in agriculture.

The relative surface pH of the particular clay granule may be acidic or basic, for example, between about 3 to about 11. The relative surface pH of the clay granule may be chosen to control the release of the first component and/or improve long-term bioavailability and/or delay release of an effective amount of the first component after application to the locus of a seed or plant. For example, clay granules with a relatively acidic surface chemistry typically have slower degradation and release properties than clay granules with a relatively basic surface chemistry. Application of the first component to a clay granular form of relatively acidic surface pH provides for long-term bioavailability of the first component with little or no loss in the efficacy while providing for the delayed release of an effective amount of the first component as compared to direct soil application of the first component.

In certain aspects, slow release granules having a pH of about 4 to about 6 with the first component are used to improve sown seed and/or plant health, growth or pest-resistance and or the delayed release of an effective amount of the first component. In other aspects, combinations of fast release clay granules having a pH of about 9 to about 10 and slow release granules having a pH of about 4 to about 6 with the first component are used to improve the health, growth or pest-resistance of a sown seed and/or plant. Such combinations of acidic/basic granular forms provides for essentially the immediate release of an effective amount of the first component followed by the delayed release of an effective amount of the first component at a predetermined latter time.

In one aspect, the first component can be sprayed onto the clay granules and dried. In another aspect, the clay granules can be tumbled with the first component, or a fluidized bed may be used. The treated clay granular form can then be applied to the locus of a sown seed and/or plant to improve its health, growth or pest-resistance.

In another aspect, the clay granular form may be applied to the locus of a sown seed or a plant and the first component can be applied essentially to the same locus, whereas at least a portion of clay granulate will be contacted with the first component to provide essentially an instant release of an effective amount of the first component to the soil and/or foliage, followed by the delayed release of an effective amount of the first component to the locus at a predetermined latter time.

In one aspect, the clay granular form is contacted with the first component combined with, or sequentially contacted by, a second component to provide a treatment for improved health, growth or stress-resistance of a sown seed or plant. In another aspect, the clay granular form can be contacted with the first component or at least one second component in sequential order to maximize the effectiveness of either component or to minimize interactions of the components and/or the clay granular form.

In one aspect, the clay granular form contacted with the first component and optionally the second component is applied to the locus essentially simultaneously with the seed, for example, as the seed is sown.

Granular Forms of Urea with First Component

In one aspect, the granular form comprises urea. The granular urea is contacted with the first component to provide a composition of matter of manufacture suitable for agricultural use. In one aspect, the granular form is a Sulfur-Coated Urea (SCU) or a Polymer-Coated Urea (PCU or ESN), herein after collectively referred to as urea granular form.

Sulfur-Coated Urea (SCU) is a controlled-release nitrogen fertilizer typically providing a NPK analysis of about 25-0-0 to about 38-0-0, and about 10-30% sulfur. SCU's typically are designed such that a quick-releasing form of nitrogen (such as urea) is provided for fast green-up and immediate feeding and a slow-release form are provided for longer-lasting nourishment.

SCU sulfur-coated urea granular form can be prepared in a number of ways, typically by spraying preheated urea granules with molten sulfur and optionally a wax. The thickness of the sulfur coating can be controlled for optimizing handling, in-loading, shipping, blending and bagging and to reduce premature break down and release of all the nitrogen at one time. SCU granules are available commerically in different granular sizes. Suitable SCU include, for example, Nu-Gro Technologies SCU® (Ontario, Canada).

In one aspect, the first component can be sprayed onto the SCU granules and dried. In another aspect, the SCU granules can be tumbled with the first component, or a fluidized bed may be used. The treated SCU granules can then be applied to the locus of a sown seed and/or plant to improve its health, growth or pest-resistance. In another aspect, the SCU granular form may be applied to the locus of a sown seed or a plant and the first component can be applied essentially to the same locus, whereas at least a portion of SCU granular form will be contacted with the first component to provide essentially an instant soil and/or foliage treatment of an effective amount of the first component and a delayed release of an effective amount of the first component to the locus at a predetermined latter time.

Coating urea with sulfur and subsequent contact with the first component provides for controlled-release of a nitrogen source and a sulfur source in combination with the first component for improved health, growth or stress-resistance of a sown seed or plant. Typically, sulfur-coated urea contacted with the first component can provide for improved health, growth or stress-resistance of a sown seed or plant essentially immediately, continuing up to about eight, nine, ten, eleven, or to about 12 weeks or more post-application, depending on environmental conditions. A sustained, controlled release of sulfur and nitrogen in combination with the first component provides for the enhanced uptake of other nutrients essential for growth, and disease resistance. The controlled-release composition comprising the SCU contacted with the first component can reduce the total number of applications and/or prevent plant injury.

In one aspect, the first component is combined with a second component (described below) and the combination is contacted with the SCU granulate to provide a treatment for improved health, growth or stress-resistance of a sown seed or plant. In another aspect, the SCU particulate can be contacted with the first component or at least one second component in sequential order to maximize the effectiveness of either component or to minimize interactions of the components and/or the SCU particulate.

Polymer Coated Urea Treated with First Component

In one aspect, the first component is contacted with a Polymer-Coated Urea (PCU or ESN) granulate to provide a controlled release form of the first component in combination with a fertilizer. Polymer-Coated Urea (PCU or ESN) is a controlled-release nitrogen fertilizer typically providing a NPK analysis similar to a SCU without the sulfur. PCU's typically are designed such that a quick-releasing form of nitrogen (such as urea) is provided for fast green-up and immediate feeding and a slow-release form are provided for longer-lasting nourishment.

PCU-coated urea can be prepared in a number of ways, typically by spraying urea granules with polymer solutions and drying. The thickness of the polymer coating can be controlled for optimizing handling—in loading, shipping, blending and bagging and to modify or adjust the release rate of the urea. For example, the release rate of the urea may be controlled by adjusting the polymer chemistry and/or polymer coating thickness. Polymer coating chemistry can be adjusted to control release of urea based on temperature and/or moisture. The polymer coating may be biodegradable or remain intact during or after urea release. Suitable PCU include, for example, POLYCON, ESN® Smart Nitrogen (Agrium Inc., Calgary, Canada).

In one aspect, the first component can be sprayed onto the PCU granulate and dried. In another aspect, the PCU granulate can be tumbled with the first component, or a fluidized bed may be used. The first component can form a coating on the polymer, penetrate the polymer coating, or both. In one aspect, the first component can be mixed or otherwise dispersed or blended with the polymer prior to coating the urea granulate.

In another aspect, the PCU granular form may be applied to the locus of a sown seed or a plant and the first component can be applied essentially to the same locus, whereas at least a portion of PCU granular form will be contacted with the first component to provide essentially an instant soil and/or foliage treatment of an effective amount of the first component and a delayed release of an effective amount of the first component to the locus at a predetermined latter time.

In another aspect, the first component is combined with a second component and the combination is contacted with the PCU granulate (or mixed with the polymer coating prior to coating of the urea particulate) to provide a treatment for improved health, growth or stress-resistance of a sown seed or plant. In another aspect, the PCU particulate can be contacted with the first component or at least one second component in sequential order to maximize the effectiveness of either component or to minimize interactions of the components and/or the PCU particulate.

Polymer coating urea with a polymer containing the first component or subsequent contact of the polymer coated urea with the first component provides for controlled-release of a nitrogen source in combination with the first component for improved health, growth or stress-resistance of a sown seed or plant. Typically, polymer-coated urea contacted with the first component can provide for improved health, growth or stress-resistance of a sown seed or plant essentially immediately, continuing up to about eight, nine, ten, eleven, or to about 12 weeks or more post-application, depending on environmental conditions. A sustained, controlled release of and nitrogen in combination with the first component provides for the enhanced uptake of other nutrients essential for growth, and disease resistance. The controlled-release composition comprising the PCU contacted with the first component can reduce the total number of applications and/or prevent plant injury.

In another aspect, the urea granular form (SCU or PCU) is used in combination with the clay granular form disclosed above, provided that at least one of the granular forms are contacted with the first component either initially or subsequently to application to a locus, to provide a controlled release form of an effective amount of the first component in combination with a fertilizer. Such combinations of clay granular forms and urea granular forms provide essentially an instant soil and/or foliage treatment of an effective amount of the first component with fertilizer, and a delayed release of an effective amount of the first component to the locus at a predetermined latter time.

Other forms of urea may be sulfur- or polymer-coated, substituted for, or combined with SCU for the practice of the disclosure herein, including coated or uncoated granular forms of urea formaldehyde (UF) and/or methylene urea (MU), for example, Formolene, FLUF, Nitro 26 CRN, Nitroform, or CoRoN). The releasing properties of the UF and MU may be controlled by adjusting the N—C—N chain length of the material. Various types of cold water soluble nitrogen (CWSN), cold water insoluble nitrogen (CWIN) and hot water insoluble nitrogen (HWIN) forms of urea and combinations thereof may be used. Isobutylene diurea (IBDU) may be used.

Various processing aids may be used to assist contacting the first component with the clay or urea granular form. Such processing aids include penetrants such as dimethylsufoxide (DMSO), alcohols, oils, tackifiers, emulsifiers, dispersants, adhesion promoters, defoamers, etc, as are generally known and practiced.

Processes for preparing a composition disclosed and described herein typically involve simple admixture of the components and the granular form. Order of addition is not generally critical. In one aspect, the amount of first component applied to the granule is chosen such that an amount of granule sufficient to uniformly cover a locus of sown seed or plant using dispensing equipment is provided. Such amounts of first component as a.i. relative to the weight of granular form is readily determined without undue experimentation by any person skilled in the art or by following the exemplary guidelines set forth in this application.

### Methods

Methods of use of the composition as described herein for soil and/or foliage treatment providing nutrition and/or for reducing susceptibility to disease of a plant are further disclosed. The granular forms (clay, SCU, PCU, etc.) treated with at least the first component, optionally with at least one second component (herein after referred to as “treated granular form”) can be applied to a single plant (e.g., a houseplant or garden ornamental), to an assemblage of plants occupying an area, or to a locus of sown seed or plant. The treated granular form can be combined with seed as the seed is introduced into or on soil or other growing media or the treated granular form can be applied to the locus after sowing or to the locus of emerged plants. In some embodiments, the composition is applied to an agricultural or horticultural crop or its locus, more especially a food crop. A “food crop” herein means a crop grown primarily for human consumption. Methods of the present invention are appropriate both for field use and in protected cultivation, for example, greenhouse use.

While the present methods can be beneficial for gramineous (belonging to the grass family) crops such as cereal crops, including corn, wheat, barley, oats and rice, they are also highly appropriate for non-gramineous crops, including vegetable crops, fruit crops and seed crops. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed.

Vegetable crops for which the present methods can be found useful include without limitation:
leafy and salad vegetables such as amaranth, beet greens, bitterleaf, bok Choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kailan, kale, komatsuna, kuka, Lagos bologi, land cress, lettuce, lizard's tail, melokhia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you choy;
flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcorn, sweet pepper, tinda, tomato, tomatillo, winter melon, West Indian gherkin and zucchini (courgette);
podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, orad bean, velvet bean, winged bean and yardlong bean;
bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;
root and tuber vegetables, such as ahipa, arracacha, bamboo shoot, beetroot, black cumin, burdock, broadleaf arrowhead, camas, canna, carrot, cassaya, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and
herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops for which the present methods can be found useful include, in addition to cereals (e.g., barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Other crops, not fitting any of the above categories, for which the present methods can be found useful include without limitation sugar beet, sugar cane, hops and tobacco.

Each of the crops listed above has its own particular nutrition and disease protection needs. Further optimization of compositions described herein for particular crops can readily be undertaken by those of skill in the art, based on the present disclosure, without undue experimentation.

Methods of using the compositions disclosed and described herein comprise applying the treated granular form as described herein to locus of sown seed or plant or a foliar surface of a plant, or essentially during sowing of the seed.

Compositions disclosed and described herein can be applied using any conventional system for applying granules to a foliar surfaces or a locus. Most commonly, application by broadcast spreading methods will be found most convenient, but other techniques may be used if desired.

For foliage or locus applications, the application rate of the treated granular form typically is adjusted based on granulate size and porosity such that amount of the first component applied to the locus or plant is equivalent to between about 0.1 gram/hectare to about 10.0 gram/hectare dry weight, between about 0.1 gram/hectare to about 7.0 gram/hectare dry weight, between 0.5 gram/hectare to about 5 gram/hectare dry weight, or between about 1 gram/hectare to about 4.0 gram/hectare dry weight of first component applied in the soil or as a foliar application to the foliage or the locus of the plant.

The frequency of application of the treated granular form disclosed and described herein can be varied depending on many factors. It may be advantageous to apply a relatively high “starter” rate, followed by one or more subsequent applications at a lower rate. In certain situations, the treated granular form provides for a single application with sustained efficacy of an effective amount of the first component. In other situations, the first and/or additional applications may precede, supersede, or correspond to a particular growth cycle of the plant, or a known life cycle or endemic habit of an insect, parasite, or undesirable plant species.

### Treated Granular Form-Seed Combinations

In one aspect, methods of promoting healthy growth of plant seeds is provided that comprises combining the treated granular form with seeds or essentially simultaneously sowing seeds with the treated granular form comprising at least the first component and optionally a second component selected from one or more pesticides. The seeds may be physically blended or mixed with the treated granular form by conventional means such as rolling, or tumbling. The seeds may be coated simultaneously with the granular form.

Thus, the treated granular form-seed combination can comprise seed and granular form contacted with a first component and optionally at least one second component. The second component can be selected from pesticides. For example, the at least one pesticide can comprise Fipronil and other fluorocyanobenpyrazoles; tebuconazole, a broad-spectrum fungicide treatment that protects against wide range of diseases in cereal grains, soybeans, and other crops as well as other members of the class of azoles; thiram, a fungicide treatment for control of damping-off, Phytophthora, and other soil-borne diseases effective in a broad range of crops; myclobutanil, a fungicide effect for sore shin and black root rot in cotton; imidacloprid and other neonicotinoids, effective for systemic, early-season insect control; metalaxyl, for systemic control of Pythium and Phytophthora: combinations of pesticides such as tebuconazole and metalaxyl; and tebuconazole, imidacloprid and metalaxyl; imazapyr (StrigAway®) to provide effective protection against Striga; zinc ions, copper ions, manganese ions, or combinations thereof (e.g., Zn+Cu, Zn+Mn). Combinations of the first component and the pesticide can be mixed in aqueous media at a concentration, and brought into contact with the seeds and/or granular form for a time sufficient to provide a loading suitable for improved plant health and/or growth.

In another aspect, a method effective in providing improved plant health, growth, or pest-resistance comprises sowing seed in combination with a treated granular form comprising the first component and optionally at least one second component comprising a plant growth regulator or hormone. The plant growth hormone can be from the class of abscisic acid, auxins, cytokinins, gibberellins, brassinolides, salicyclic acid, jasmonates, plant peptides, polyamines, and stringolactones.

In another aspect, methods of promoting healthy growth of planted seeds is provided that comprises applying to the locus of sown seeds a treated granular form wherein the treated granular form comprises a coating or dressing of a polymer or other matrix, the polymer or matrix comprising the first component and optionally one or more second components. The polymer or matrix is capable of releasing the first component and optionally one or more pesticides and/or one or more natural plant hormones (collectively, “the actives”). The polymer or matrix can be designed to release the actives in response to temperature, moisture content, sunlight, time, or combinations thereof. The polymer or matrix can controllably dissolve or disintegrate, releasing the actives, or can controllable release the actives over time or in response to a predetermined condition such as temperature, moisture content, sunlight, time, or combinations thereof. The polymer or matrix can be multi-layer, with discrete layers, for example, for disrupting the coating to allow moisture ingress, housing the actives, etc. Suitable polymers or matrixes include hydrogels, microgels, sol-gels. Specific materials and methods of coating granulates are those processes also suitable for coating seeds and include such process as, for example, Intellicoat™ (Landec Inc., Indiana); ThermoSeed™ (Incotec, Netherlands) CelPril™ (Bayer CropScience); ApronMaxx™ (Syngenta); and Nacret™ (Syngenta). The actives can be provided as nanoparticles and incorporated into the polymer or matrix, or directly adhered to the granulate via electrostatic or other forces. The thickness of the polymer or matrix coating may be between from about 0.01 mils to about 10 mils in thickness, however, other thickness may be used. The coating can further provide protection for the granules from mechanical and environmental damages.

### Synergistic Compositions for Plant Health

Methods and treated granular form compositions as described in detail above are useful for nutrition of a plant. Any unpredicted benefit of enhanced nutrition can be a benefit of the present methods, including without limitation, higher quality produce, improved growth and/or a longer growing season (which in either case can lead to higher yield of produce), improved plant stress management including increased stress tolerance and/or improved recovery from stress, increased mechanical strength, improved root development, improved drought resistance and improved plant health. Combinations of unpredicted benefits can be obtained.

In various embodiments, yield of produce can be unpredictably increased, for example by at least about 2%, at least about 4%, at least about 6%, at least about 8%, at least about 10%, at least about 15%, at least about 25% or at least about 50%, over plants not receiving a nutrient treatment.

Improved plant health, particularly resistance to or protection from disease, especially bacterial or fungal disease, is an important benefit of methods disclosed and described herein. In one embodiment, a method is provided for reducing susceptibility of a plant to insect, fungal or bacterial disease. “Reduced susceptibility” herein includes reduced incidence of fungal or bacterial infection and/or reduced impact of such infection as occurs on the health and growth of the plant. It is believed, without being bound by theory, that the enhanced nutrition afforded by compositions disclosed and described herein strengthens the plant's natural defenses against fungal and bacterial pathogens. Examples of such pathogens include, without limitation, Alternaria spp., Blumeria graminis, Bottytis cinerea, Cochliobolus miyabeanus, Colletotrichum gloeosporioides, Diplocarpon rosae, Fusarium oxysporum, Magnaporthe grisea, Magnaporthe salvinii, Phaeosphaeria nodorum, Pythium aphanidermatum, Pythium ultimum, Sclerotinia homoeocarpa, Septoria nodorum, Sphaerotheca pannosa, Sphaerotheca xanthii, Thanatephorus cucumeris and Uncinula necator.

A single species of pathogen can cause a variety of different diseases in different crops. Examples of bacterial and fungal diseases of plants include, without limitation, anthracnose, armillaria, ascochyta, aspergillus, bacterial blight, bacterial canker, bacterial speck, bacterial spot, bacterial wilt, bitter rot, black leaf, blackleg, black rot, black spot, blast, blight, blue mold, botrytis, brown rot, brown spot, cercospora, charcoal rot, cladosporium, clubroot, covered smut, crater rot, crown rot, damping off, dollar spot, downy mildew, early blight, ergot, erwinia, false loose smut, fire blight, foot rot, fruit blotch, fusarium, gray leaf spot, gray mold, heart rot, late blight, leaf blight, leaf blotch, leaf curl, leaf mold, leaf rust, leaf spot, mildew, necrosis, peronospora, phoma, pink mold, powdery mildew, rhizopus, root canker, root rot, rust, scab, smut, southern blight, stem canker, stem rot, verticillium, white mold, wildfire and yellows.

### EXPERIMENTAL EXAMPLES

### Experiment 1

### Clay Granulate Delayed Release of First Component

The purpose of this experiment was to evaluate the use of engineered clay granules (Verge Granules obtained from Oil Dri Corporation, Chicago) as an absorbent, controlled releasing carrier for the first component and to determine the effect of granule size and rate of break down on the release and efficacy of the first component when used in combination with a granular fertilizer. The study was conducted in a greenhouse using corn (Zea mays) as the test crop. During the course of the study plants were evaluated for plant weight at 20, 34, and 54 days after emergence (DAE).

For this experiment, 4 different clay granules were used, differing in size of granules and the time required for them to break down after application. There were two different sizes of granules, designated 200 SGN and 140 SGN, with a bulk density of about 200,000 granules per pound to 400,000 granules per pound. For each granule size there were two different disintegration rates, an almost immediate disintegration rate when contacted with moisture, and a slower more controlled disintegration when contacted with moisture. There is a significant difference in the relative pH of the two granules as well. The slowly disintegrating granules have a relative pH of about 4 to about 6 while the rapidly disintegrating granules have a relative pH of about 9 to about 10. For the experimental samples, the first component was sprayed on the granules at a rate of 1.4 g a.i./2.85 kg of granules (effective rate of about 3.5 g a.i./hectare).

All seed was planted in 6″ diameter pots containing 5 kg of soil per pot. There were 6 pots per treatment and 20 seed were planted in each pot, ˜½ inch deep. Un-treated granular NPK fertilizer was applied to the surface of each pot at a rate that was essentially equivalent to field application of 120 pounds of N, 60 pounds of P as P₂O₅, and 40 pounds of K as K₂O. The six treatments are summarized in Table F.

TABLE F

| Treatment # | Treatment |
|---|---|
| 1 | Granular Fertilizer only (un-treated granular NPK) |
| 2 | Granular Fertilizer, and the first component applied directly |
| | to the soil surface in 20 locations |
| 3 | Granular Fertilizer, and 20 granules of SGN140 Slow clay |
| | granular form contacted with the first component |
| 4 | Granular Fertilizer, and 20 granules of SGN200 Slow clay |
| | granular form contacted with the first component |
| 5 | Granular Fertilizer, and 20 granules of SGN140 clay |
| | granular form contacted with the first component |
| 6 | Granular Fertilizer, and 20 granules of SGN200 clay |
| | granular form contacted with the first component |

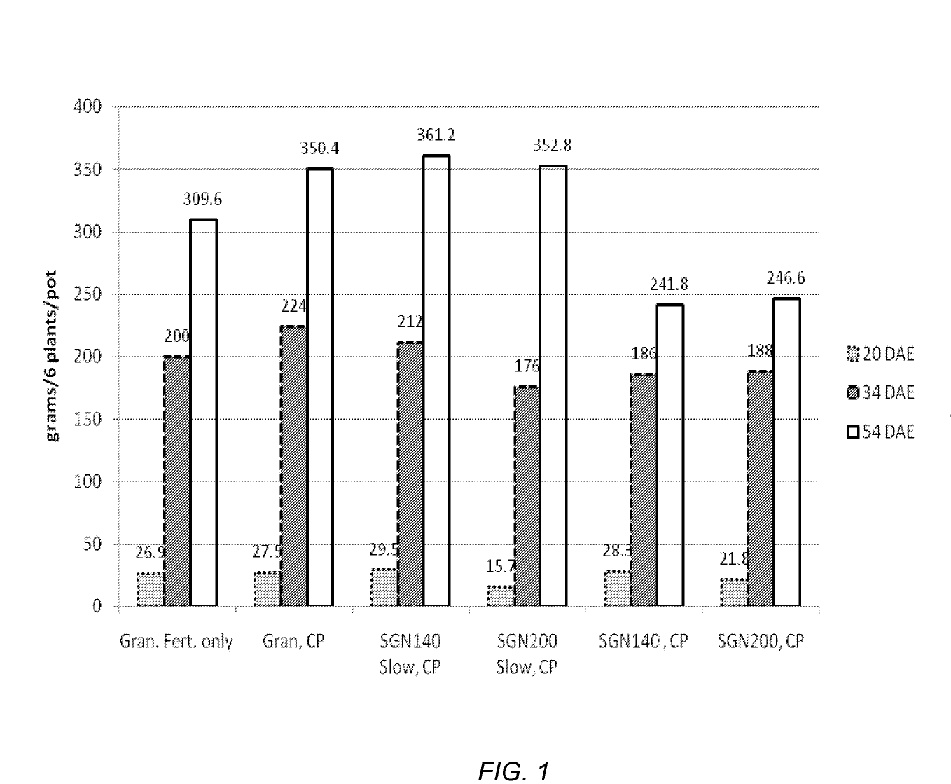

The amount of first component applied in each treatment was equivalent to about 0.01 mg a.i. per 6″ diameter soil surface. As shown in FIG. 1, the results of this experiment showed the following unpredicted results: 1) the size of the granule used did not significantly effect the release rate of the first component; 2) the disintegration rate of the treated granular form effects the delayed release of an effective amount of the first component to the plant locus and the duration of the benefit from the first component compared to a direct soil treatment of the first component (data not shown); and 3) more slowly disintegrating treated granular form provided the best long-term performance of a delayed release of an effective amount of the first component, most notably, when evaluated at 54 DAE.

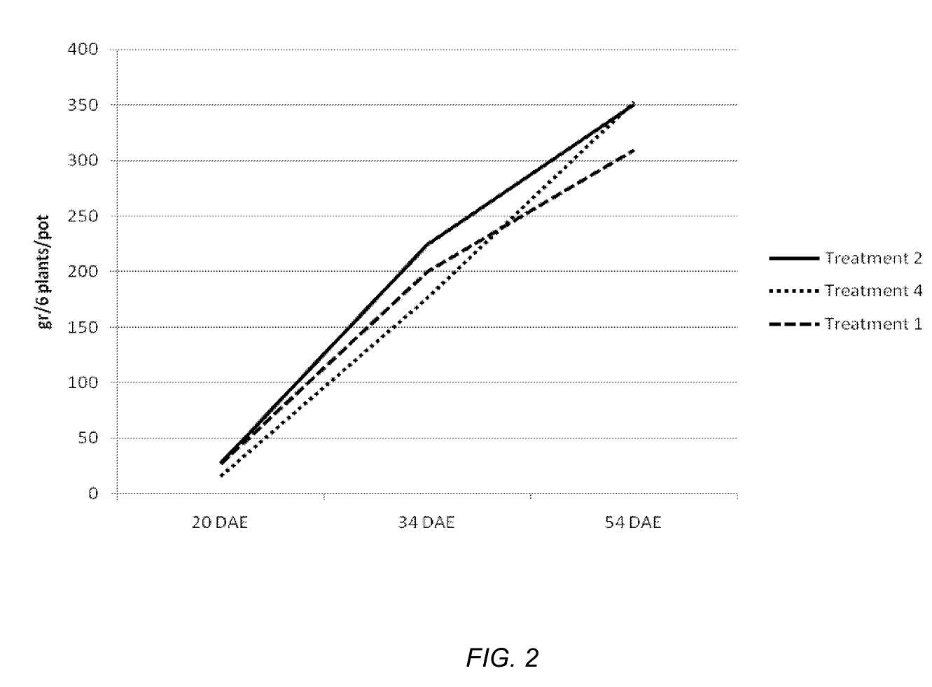

As shown in FIG. 2, comparing only the results of Treatments #'s 1, 2 and 4, clear differences in plant weights over time were observed. Both the granular fertilizer alone (#1) and the granular fertilizer with the first component applied directly only to the soil (#2) increase plant weight initially significantly more than the granular fertilizer with the SGN200 Slow clay granular form treated with the first component (#4). However, after about 34 days, the rate of growth slowed for the granular fertilizer (#1) and granular fertilizer and the first component applied only to the soil (#2), while the locus treated with the granular fertilizer and SGN200 Slow granular form contacted with the first component (#4) provided for plants with increased growth rate. This results were unpredicted, and demonstrate that an effective amount of the first component is being released by the granular form at a predetermined time later than the original application, and as a result, providing nutrient enhancement later in the growth cycle of the plant, for example, at a time when nutrient demand is, or is expected to, increase.

### Experiment 2

### Coated Urea Granular Form Contacted with First Component

Experiments were conducted in a small plot replicated trial on spring wheat, using a polymer coated urea (ESN, Agrium) as a urea granular form, with and without contact with the first component. The Control for this trial was an application of untreated granular NPK fertilizer where the N was present as polymer coated urea (ESN). In the second treatment, the first component was sprayed onto the polymer coated urea granules, but the P and K granules in the fertilizer blend were not treated. In the third treatment, the first component was applied to all of the granular fertilizer, e.g., the N, P and K granules. In treatments 2 and 3 the first component was applied so that the final amount of active ingredient was equivalent to about 3.0 g/ha. The plots all received essentially the same amount of NPK fertilizer. Visual observations during the growing period of the spring wheat indicated the first component treated plots had unpredicted greater biomass and larger root systems than that of the Control. Further, the growth and/or health of the plots with the first component only on the ESN granules appeared to be better than the plots treated with the first component applied to all of the NPK granules. This data was also unpredicted.

Additional Experiments were conducted in series of replicated trials on several crops including rice, maize, and wheat using NPK fertilizers contacted with the first component, where the NPK fertilizer consisted of a combination of a slow release nitrogen source (sulfur coated urea) with un-coated NPK granules. The same NPK fertilizer, but without the first component, was the Control. The application rate of the first component was equivalent to about 3.0 g/ha of active ingredient. Visual observations indicated that the first component treated plots had greater biomass and larger root systems than the Control. The greater biomass obtained by the combination of the first component and the NPK fertilizer was not predicted.

### Experiment 3

### Yield Increase—Potatoes

In this experiment, yield results were determined for potatoes treated with NPK fertilizer impregnated with the first component versus potatoes treated with NPK fertilizer without the first component. Fertilizer with first component was applied in strips across the field that alternated with strips treated with NPK fertilizer only. The rate of NPK fertilizer (16-13-16 blend) was 1235 kg/ha and the first component was applied at a rate of 1.5 grams/ha. At harvest, a 15 foot section of a row in each strip was harvested and the weight measured for all the potatoes, which was recorded as pounds per 15 foot row. Results are shown in Table 1.

TABLE 1
Yield results in pounds per 15 foot row from five Maine, USA potato farms.

| | Farm 1 | | Farm 2 | | Farm 3 | | Farm 4 | | Farm 5 | |
|---|---|---|---|---|---|---|---|---|---|---|
| | CP | No CP | CP | No CP | CP | No CP | CP | No CP | CP | No CP |
| Rep. 1 | 44.75 | 36.25 | 39 | 34 | 35.25 | 24.5 | 31 | 27 | 39 | 27 |
| Rep. 2 | 44.75 | 36 | 37.5 | 35 | 34.25 | 26.5 | 34 | 28.5 | 44 | 35 |
| Rep. 3 | 44.5 | 34.75 | 37 | 33.5 | 33.25 | 30 | 29 | 26 | 49 | 25 |
| Average | 44.7 | 35.7 | 37.8 | 34.2 | 34.3 | 27.0 | 31.3 | 27.2 | 44.0 | 29.0 |

The differences for each farm between the first component (“CP”) and No first component (“No CP”) strips are statistically significant at p < 0.10.

From this experiment, the results show that impregnating granular fertilizer with first component significantly increased yields. The potato typically is a crop that requires large quantities of nutrients to produce optimum crop yields, and in this experiment, the first component increased the availability and uptake of nutrients, leading to increased yields. The greater nutrient uptake and corresponding yield enhancement obtained by the combination of the first component and the NPK fertilizer was not predicted.

### Experiment 2

### Nutrient Uptake Increase and Yield Increase—Maize

In this experiment conducted on a commercial farm in South America, where a 10 hectare maize field was divided into two 5 hectare strips, one was treated with granular Monoammonium Phosphate (MAP) fertilizer only, and the other with MAP impregnated with first component. Both strips received 90 kg/ha of MAP, and the first component was applied at a rate of 1 gram/ha. At harvest, the strip treated only with MAP yielded 9404 kg/ha while the treated strip yielded 10,194 kg/ha, an 8.4% yield increase. Maize yields are generally known to be directly dependent upon the amount of nutrient available to them, so the yield increase can be directly correlated to an increase in availability of nutrients in the strip treated with the MAP plus first component versus the strip treated only with MAP.

### Experiment 3

### Chlorophyll Content Increase and Yield Increase Experiments

Wheat trials to evaluate the effectiveness of first component impregnated on granular fertilizer to increase chlorophyll content in wheat leaf tissue were conducted in Western North America. Chlorophyll is a fundamental compound in photosynthesis and is responsible for capturing energy from the sun and using it to create energy for the plant. Chlorophyll absorbs light most strongly in the blue and red but poorly in the green portions of the electromagnetic spectrum; hence the green color of chlorophyll-containing tissues such as plant leaves. These trials were conducted in small plots utilizing a randomized complete block design experiment with 4 replicates. Trials were conducted at four sites and fields were fertilized according to soil test recommendations using an appropriate NPK granular fertilizer blend. Plot sizes were 2.0 by 6.0 m. Fertilizer impregnation was accomplished by using a jar and applying the appropriate volume of first component to the fertilizer and mixing thoroughly. Chlorophyll data was collected using a Minolta SPAD—502 chlorophyll meter. Ten leafs per plot where measured and an average was calculated for each plot to obtain representative chlorophyll readings. Results are shown in Table 2.

TABLE 2
Chlorophyll Content of Wheat Leaves.

| Treatment | | | | |
|---|---|---|---|---|
| Granular | 40.7c | 43.9b | 40.5c | 42.0c |
| Fertilizer | | | | |
| Granular | 49.4a | 49.5a | 48.1ab | 48.8ab |
| Fertilizer + | | | | |
| 1 gm/ha CP | | | | |
| Granular | 48.2ab | 49.8a | 49.0a | 51.1a |
| Fertilizer + | | | | |
| 2 gm/ha CP | | | | |

Means in each column followed by the same letter do not differ significantly. (P = 0.05, Duncan's New MRT)

This experiment clearly demonstrated the effect of first component in moving nutrients into the plant to enhance plant activity and increasing chlorophyll content, leading to increased photosynthesis and overall plant health. The greater nutrient uptake and corresponding chlorophyll enhancement obtained by the combination of the first component and the fertilizer was not predicted.

### Experiment 4

### Excess Nitrogen Mitigation and Height Improvement

This experiment was a greenhouse experiment designed to demonstrate the effect of first component impregnated urea versus urea containing no first component at various rates of urea. The trial was arranged in a randomized complete block design with 5 replicates per treatment. For the first component treated pots, the first component was impregnated directly on the urea granules. The appropriate amount of fertilizer was mixed with the top 3 centimeters of soil and then the seeds were planted. At 26 days after the seed emerged, height measurements were made of all the plants and the results are shown below in Table 3.

TABLE 3
Plant height measurements taken 26 days after emergence.

| Units N (kg/ha) | Dose CP (g/ha) | Average Ht. (cm) |
|---|---|---|
| 75 | 0.0 | 26.40bc |
| 75 | 0.6 | 27.61ab |
| 100 | 0.0 | 26.08cd |
| 100 | 0.6 | 27.93ab |
| 125 | 0.0 | 25.35cd |
| 125 | 0.6 | 27.81ab |
| 150 | 0.0 | 23.31f |
| 150 | 0.3 | 24.52de |

Means in each column followed by the same letter do not differ significantly. (P = 0.05, Duncan's New MRT)

This data clearly shows the effect of first component in enhancing the plants ability to utilize nitrogen, leading to greater plant height compared to equal amounts of nitrogen without first component. Even at the highest levels of Nitrogen (Units N (kg/ha)) where it is present in excess, the first component mitigates some of the effect of the excess Nitrogen and increases plant height compared to the plants without the first component. The greater plant height and excess nitrogen mitigation obtained by the combination of the first component and the fertilizer was not predicted.

The words “comprise,” “comprises,” and “comprising” are to be interpreted inclusively rather than exclusively.

What is claimed is:

1. A composition of matter comprising:
a granular form contacted with a first component comprising an agriculturally acceptable complex mixture of organic material characterized by natural organic matter that is partially humified.

2. The composition of matter of claim 1, wherein the first component is characterized by two or more of:
a. a mixture of condensed hydrocarbons, lignins, and tannins and/or condensed tannins;
b. an oxygen to carbon ratio for the dissolved organic matter of greater than about 0.5;
c. a total number of tannin compounds greater than about 200, the tannin compounds having a hydrogen to carbon ration of about 0.5 to about 1.4, and an aromaticity index of less than about 0.7 as measured by mass spectroscopy; or
d. a mass distribution of about 55-60% lignin compounds, 27-35% tannin compounds, and about 8-15% condensed hydrocarbon as measured by mass spectroscopy.

3. The composition of matter of claim 1, wherein the first component comprises a mixture of condensed hydrocarbons, lignins, and tannins and/or condensed tannins, characterized in that at least 10% of the total % of compounds of the composition are tannins and/or condensed tannins.

4. The composition of matter of claim 1, wherein the first component comprises a mixture of condensed hydrocarbons, lignins, and tannins and/or condensed tannins, wherein at least 20% of the total % of compounds of the composition are tannins and/or condensed tannins.

5. The composition of matter of claim 1, further comprising a second component, the second component is at least one agriculturally acceptable pesticide, micronutrient, macronutrient, growth regulator, and mixtures thereof.

6. The composition of matter of claim 5, wherein the pesticide is at least one herbicide, insecticide, fungicide, bactericide, anti-viral, and combinations thereof.

7. The composition of matter of claim 1, wherein the granular form comprises at least one of montmorillonite, attapulgite, aluminosilicate, urea, urea formaldehyde, methylene urea, isobutylene urea, sulfur-coated urea, and polymer-coated urea.

8. The composition of matter of claim 1, wherein the granular form is montmorillonite, attapulgite, or aluminosilicate.

9. The composition of matter of claim 7, wherein the granular form is polymer coated urea or sulfur-coated urea.

10. The composition of matter of claim 1, wherein release of the first component from the granular form is delayed.

11. A method of improving plant health, the method comprising the step of:
contacting a locus of a sown seed or plant species with a granular form and a first component comprising an agriculturally acceptable mixture of partially humified natural organic matter;
wherein, in the contacting step, the first component is initially or subsequently dispersed on at least a portion of granular form, or mixed or admixed with the granular form.

12. The method of claim 11, wherein the first component comprises two or more of:
(a) a mixture of condensed hydrocarbons, lignins, and tannins and/or condensed tannins;
(b) a an oxygen to carbon ratio for the dissolved organic matter of greater than about 0.5;
(c) a total number of tannin compounds greater than about 200, the tannin compounds having a hydrogen to carbon ration of about 0.5 to about 1.4, and an aromaticity index of less than about 0.7 as measured by mass spectroscopy; or
(d) a mass distribution of about 55-60% lignin compounds, 27-35% tannin compounds, and about 8-15% condensed hydrocarbon as measured by mass spectroscopy.

13. The method of claim 11, wherein the first component comprises a mixture of condensed hydrocarbons, lignins, and tannins and/or condensed tannins, characterized in that at least 10% of the total % of compounds of the composition are tannins and/or condensed tannins.

14. The method of claim 11 or 12, wherein the first component comprises a mixture of condensed hydrocarbons, lignins, and tannins and/or condensed tannins, characterized in that at least 20% of the total % of compounds of the composition are tannins and/or condensed tannins.

15. The method of claim 11, further comprising contacting the locus with a second component wherein the second component is at least one of agriculturally acceptable pesticides, micronutrients, macronutrients, growth regulators, and mixtures thereof.

16. The method of claim 15, wherein the pesticide is a herbicide, insecticide, fungicide, bactericide, anti-viral, or combinations thereof.

17. The method of claim 11, wherein the granular form is coated with sulfur or a polymer.

18. The method of claim 11, wherein the granular form is urea coated with sulfur or a polymer.

19. The method of claim 17, wherein the polymer or sulfur releasably contains the first component.

20. The method of claim 15, wherein the granular form comprises the second component.

21. The method of claim 11, further comprising enhancing one or more of germination, emergence, root development, and nutrient uptake of the sown seed or plant species is provided compared to the locus of a sown seed or plant species not contacted with the granular form and the first component.

22. The method of claim 21, further comprising contacting the locus with a second component wherein the second component is selected from agriculturally acceptable pesticides, micronutrients, macronutrients, growth regulators, and mixtures thereof.

23. The method of claim 25, wherein the pesticide is at least one of a herbicide, insecticide, fungicide, bactericide, anti-viral, or combinations thereof.

24. The method of claim 21, wherein the granular form comprises a polymer-coated urea or a sulfur-coated urea.

25. The method of claim 27, wherein the polymer-coated urea or the sulfur-coated urea releasably contains the first component.

26. The method of claim 25, wherein the granular form further comprises the second component.

27. The method of claim 25, further comprising enhancing pesticidal activity of the pesticide; improving nutrient uptake of the plant or seed; or enhancing pesticidal activity of the pesticide and improving nutrient uptake of the plant or seed.

28. A method for providing delayed release nutrition for a plant or seed species, the method comprising
contacting the locus or the foliar surface of a plant or a seed species with a granular form and a first component comprising an agriculturally acceptable mixture of partially humified natural organic matter, wherein, in the contacting step, the first component is initially or subsequently dispersed on at least a portion of granular form, or mixed or admixed with the granular form; and
wherein the release of an effective amount of the first component from the granular form is delayed for a predetermined time after the contacting step.

29. The method of claim 28, wherein the first component is characterized by two or more of:
a. a mixture of condensed hydrocarbons, lignins, and tannins and/or condensed tannins;
b. a an oxygen to carbon ratio for the dissolved organic matter of greater than about 0.5;
c. a total number of tannin compounds greater than about 200, the tannin compounds having a hydrogen to carbon ration of about 0.5 to about 1.4, and an aromaticity index of less than about 0.7 as measured by mass spectroscopy; or
d. a mass distribution of about 55-60% lignin compounds, 27-35% tannin compounds, and about 8-15% condensed hydrocarbon as measured by mass spectroscopy.

30. The method of claim 28, wherein the first component is characterized by comprising a mixture of condensed hydrocarbons, lignins, and tannins and/or condensed tannins, characterized in that at least 10% of the total % of compounds of the composition are tannins and/or condensed tannins.

31. The method of claim 28, wherein the first component is characterized by comprising a mixture of condensed hydrocarbons, lignins, and tannins and/or condensed tannins, characterized in that at least 20% of the total % of compounds of the composition are tannins and/or condensed tannins.

32. The method of claim 11, wherein the granular form has an acidic surface chemistry or a basic surface chemistry.

33. The method of claim 28, wherein the granular form has an acidic surface chemistry or a basic surface chemistry.

34. The method of claim 11, further comprising seed of a non-gramineous crop, a seed of a fruit or vegetable crop, or a genetically modified seed.

35. The method of claim 28, further comprising seed of a non-gramineous crop, a seed of a fruit or vegetable crop, or a genetically modified seed.

36. The method of claim 11, wherein the yield of a plant sown in predetermined size locus is increased compared to the same plant sown in the same predetermined size locus.

37. The method of claim 11, wherein the amount of chlorophyll of a plant species is increased compared to the same plant species not contacted with the first component.

38. The method of claim 11, wherein the effect of excess nitrogen on a plant is reduced compared to the same plant not contacted with the first component.
